(19) United States
(12) Patent Application Publication
(10) Pub. No.: US 2011/0101096 A1
(43) Pub. Date: May 5, 2011

(54) IDENTIFICATION CARD AND NETWORK SYSTEM USING THE SAME

(75) Inventor: Masami Tawara, Saitama (JP)

(73) Assignee: OPTOELECTRONICS CO., LTD., Warabi-shi (JP)

(21) Appl. No.: 12/698,617

(22) Filed: Feb. 2, 2010

(30) Foreign Application Priority Data
Oct. 30, 2009 (JP) 2009-251407
Dec. 28, 2009 (JP) 2009-298927

(51) Int. Cl. G06F 17/00; G06K 19/00; G06K 5/00; G06K 7/10; G08B 3/10

(52) U.S. Cl. 235/382; 235/492; 235/380; 340/384.7

(57) ABSTRACT

An identification card contains an identification portion that contains identification information for identifying a person, a wireless-information-receiving portion that receives wireless information, an output-information-generating portion that generates output information from the wireless information received by the wireless-information-receiving portion, and an output-information-displaying portion that receives the output information from the output-information-generating portion to display the output information. The identification card can identify the person and receives the output information from the output-information-generating portion to display the output information.

### BACKGROUND OF THE INVENTION

1. Field of the Invention

The present invention relates to an identification card and a network system using the same. It particularly relates to an employee identification card or the like and a network system using such an employee identification card.

2. Description of Related Art

An identification card that describes any information indicating an identity of a person, such as an employee identification card, a student identification card and a driver's license has been widely used. Further, an integrated circuit (IC) card has recently come into wide use and has been often used in the identification card. The identification card with IC may be also used as an employee identification card or an electronic key to be used when entering into a building of a firm, a company or the like. The identification card with IC maybe also used as an identification key to be used when using a network or a personal computer within a firm, a company or the like.

Japanese Patent Application Publication No. H08-258469 has disclosed an electronic name card having a paging function, which is capable of receiving a message or the like. The electronic name card has liquid crystal display means at both of a front side thereof and a rear side thereof. The liquid crystal display means at the front side displays any name card information including names of a person and his or her company or the like. The liquid crystal display means at the rear side displays a message or the like received using the paging function.

Japanese Patent Application Publication No. 2002-24784 has disclosed an identification card that identifies a holder of this identification card. The identification card is provided with a memory that stores identification information indicating a personal characteristic mark such as a fingerprint, a detection portion that detects the personal characteristic mark, and a collation portion that collates the personal characteristic mark detected by the detection portion with the personal characteristic mark stored in the memory.

### SUMMARY OF THE INVENTION

The electronic name card disclosed in Japanese Patent Application Publication No. H08-258469, however, has no IC so that it is difficult to function as an electronic key to be used when entering a building of a firm, a company or the like by utilizing the electronic name card as an employee identification card.

The identification card disclosed in Japanese Patent Application Publication No. 2002-24784 has not any communication function with an exterior network so that it is difficult to receive information from the exterior network and to display the information.

By the way, on a staff meeting in a company, each staff may use an information appliance such as a personal computer and a cellular phone to share information. In this case, it is convenient for each staff to have an identification card having an IC card function and a partial function of the information appliance together in order to get a brief schedule and/or events immediately.

It is thus desirable to provide an identification card, which can identify a person and receive any information from the exterior network to display the information, and a network system using the same.

According to an embodiment of the present invention, there is provided an identification card containing an identification portion that contains identification information for identifying a person, a wireless-information-receiving portion that receives wireless information, an output-information-generating portion that generates output information from the wireless information received by the wireless-information-receiving portion, and an output-information-displaying portion that receives the output information from the output-information-generating portion to display the output information.

According to another embodiment of the present invention, there is provided a network system containing a wireless network that sends wireless information using a radio wave, an identification card that contains identification information for identifying a person and receives the wireless information from the wireless network to display the wireless information, and an identification network that reads the identification information from the identification card to identify the person.

In the above-mentioned embodiments of the present invention, the wireless network sends wireless information using a radio wave. The identification card receives the wireless information from the wireless network to display the wireless information. The identification network reads the identification information from the identification card to identify the person. Thus, only the identification card may function as a card of identity, as an electronic key for controlling entrance and exit of a person and as an information terminal that receives the information to display the information.

The identification card stores the output information in the output-information-storing portion. The switching portion switches the output information stored in the output-information-storing portion. The output-information-displaying portion displays the output information switched by the switching portion successively.

The identification information includes an identification cord and the identification-cord-reading device of the identification network scans the identification cord to read the identification information. The identification controller collates the identification information read by the identification-cord-reading device with the previously registered identification information to allow for opening a gate of a building when the pieces of the identification information are agreed with each other.

The identification card may transmit the identification information using a radio wave. The identification-information-reading device of the identification network receives and reads the identification information. The identification card is used for opening agate of a building by using the read identification information.

The identification card according to the above-mentioned embodiment of the present invention can identify a person and display the information received from the wireless network. Thus, only the identification card may function as a card of identity, as an electronic key for controlling entrance and exit of a person and as an information terminal that receives the information to display the information.

The network system according to the above-mentioned embodiment of the present invention enables the identification card to suitably identify a person by the identification network and display the information received from the wireless network.

The concluding portion of this specification particularly points out and directly claims the subject matter of the present invention. However those skill in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1A is a block diagram showing a configuration of an identification network system 100 according to an embodiment of the invention;

FIG. 1B is a block diagram showing a case where an ID card 105 receives different species of information from base stations 160a, 160b . . . , and 160n in an identification network system 100;

FIG. 2 is a diagram showing an employee wearing the ID card 105;

FIG. 3 is a diagram showing another embodiment of the identification network system 100;

FIG. 4A is a front view of an identification card 105 for showing its external appearance;

FIG. 4B is a side view thereof;

FIG. 5 is a block diagram showing a configuration of a control system in the identification card 105;

FIGS. 6A and 6B are respective front views of the identification cards 105 for the employee;

FIGS. 7A and 7B are respective front views of the identification cards 105 for the employee;

FIGS. 8A and 8B are respective front views of the identification cards 105 for guests;

FIG. 9 is a front view of the identification card 105 for a guest;

FIG. 10 is a diagram showing a use example (part one) of the ID card 105;

FIG. 11 is a diagram showing a use example (part two) of the ID card 105;

FIG. 12 is a diagram showing an information-acquiring example (part one) of the ID card 105;

FIG. 13 is a diagram showing an information-acquiring example (part two) of the ID card 105;

FIG. 14 is a diagram showing an operation example of a gate station 130C or 130D;

FIG. 15 is a block diagram showing a configuration of a control system in an identification card 105A;

FIG. 16 is a block diagram showing a configuration of a fingerprint-authenticating unit 320;

FIGS. 17A and 17B are respective front views of the identification cards 105A;

FIG. 18 a block diagram showing a configuration of a control system in an identification card 105B;

FIG. 19 is a block diagram showing a configuration of a password-authenticating unit 340;

FIGS. 20A and 20B are respective front views of the identification cards 105B;

FIG. 21 is a block diagram showing a configuration of a control system in an identification card 105C;

FIG. 22 is a front view of the identification card 105C showing a displayed example thereof; and

FIG. 23 is a front view of the identification card 105C showing a displayed response example thereof.

### DETAILED DESCRIPTION OF THE PREFERRED EMBODIMENTS

Embodiments of an identification card and a network system using the same according to the present invention will be described below with reference to the attached drawings.

### Embodiment

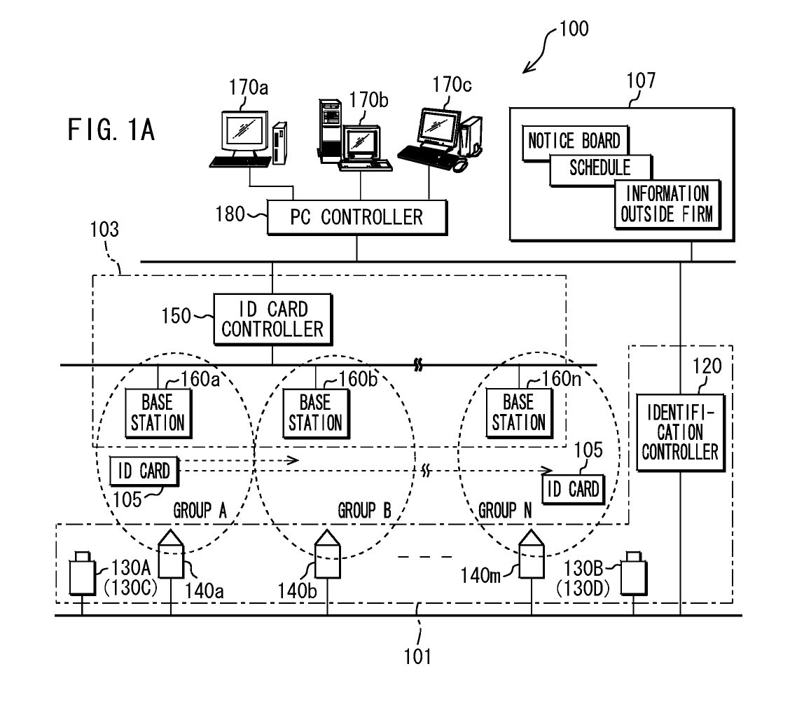

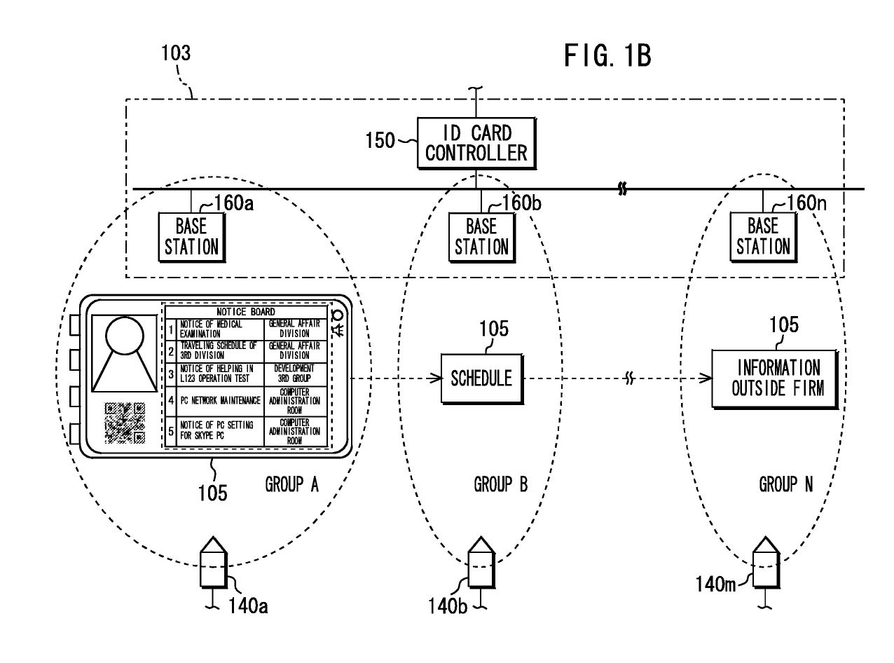

The following will describe a configuration of an identification network system 100 with reference to FIG. 1A. The identification network system 100 contains an identification network 101, a wireless network 103 that sends wireless information, an identification (ID) card 105, and a server 107. The server 107 belongs to both of the identification network 101 and the wireless network 103.

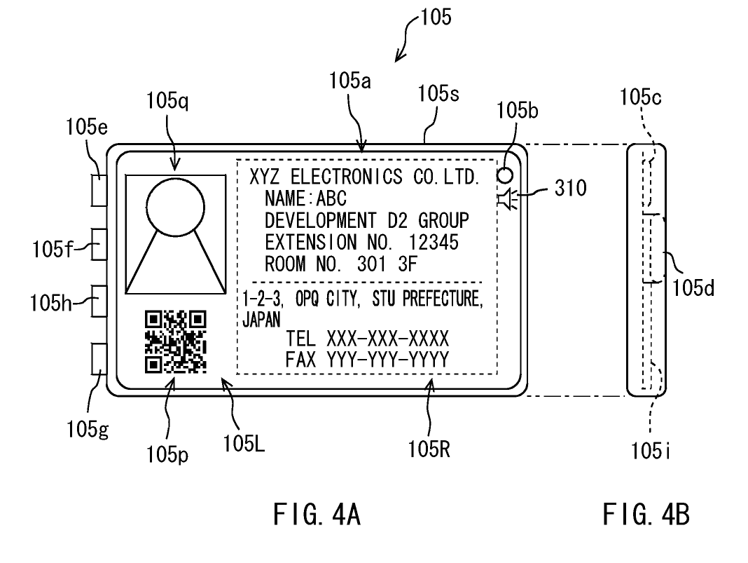

The identification network 101 reads identification information from the ID card 105 to identify a person, for example, a firm's employee, who is a holder of the ID card 105. A cord (a bar cord or two-dimensional bar code) symbolizes the identification information. A display device 105a of the ID card 105 displays the cord (see FIG. 4). The identification information contains an identification number, a name, a password of a person and the like.

The identification network 101 is arranged in a firm. The identification network 101 includes an identification controller 120, gate stations 130A and 130B, fixed stations 140a, 140b . . . and 140m (m is an optional number) and the server 107. The gate station 130A or 130B is an example of a cord-scanning apparatus and scans the cord of the ID card being held toward the gate station 130A or 130B, to read the identification information of a person from the ID card 105. The identification controller 120 controls an entrance or exit of the person into or from a building of a firm by using the identification information read by the gate station 130A or 130B.

In this embodiment, the gate station 130A is arranged near an entrance of the building of the firm and scans the cord of the ID card 105 to read the identification information including the identification number, the name and the password of the person who enters. The gate station 130A outputs the read identification number and the read password of the person to the identification controller 120. The identification controller 120 receives the identification number and the password of the person. The identification controller 120 collates the identification number and the password of the person in the identification information received from the gate station 130A with an identification number and a password of the same person in the identification information previously registered therein. The identification controller 120 thus allows the person to be entered into the building by opening a gate at the entrance of the building when these identification numbers are agreed with each other and these passwords are agreed with each other. The identification controller 120 stores the identification number of the person who has been identified by the identification information as information indicating a state where he or she has been already entered into the building.

On the other hand, the gate station 130B is arranged near an exit of the building of the firm and scans the cord of the ID card 105 to read the identification information including the identification number, the name and the password of the person who exits. The gate station 130B outputs the read identification information including the identification number and the password of the person to the identification controller 120.

The identification controller 120 receives such identification information from the gate station 130B and determines whether or not the identification number of the received identification information corresponds to the identification number, which has been stored in the identification controller 120, of the person who has been already entered into the building. If the identification number of the received identification information does not correspond to the stored identification number, a sound of alarm starts. If the identification number of the received identification information corresponds to the stored identification number, the identification controller 120 collates the identification number and the password on the person in the identification information received from the gate station 130B with the identification number and the password of the same person in the identification information previously registered therein. The identification controller 120 thus allows the person to be exited from the building by opening a gate at the exit of the building when these identification numbers are agreed with each other and these passwords are agreed with each other. The identification controller 120 stores the identification information of the person who has been identified by the identification information as information indicating a state where he or she has been already exited from the building after his or her entrance has been released.

The wireless network 103 shown in FIG. 1A transmits information such as a schedule using wireless communication. In this embodiment, the wireless network 103 contains an ID card controller 150, base stations 160a, 160b . . . , and 160n (n is an optional number) and the server 107. The server 107 stores a notice board, the schedule and information outside the firm, and the like. Personal computers 170a through 170c, which are connected to the wireless network 103 through a personal computer controller 180, set the above-mentioned pieces of information in the server 107.

The notice board stored in the server 107 indicates a notice when using a facility, which is to be informed in the firm, a network maintenance, an event in the firm and the like. A coordinator in the firm suitably sets the notice, the network maintenance, the event and the like. The schedule stored in the server 107 indicates any schedule of an employee, on the basis of which no problem occurs when it is opened. The information outside the firm, which is stored in the server 107, is transmitted to the ID card 105 which displays such information for publicity purposes when a guest is visited. The server 107 outputs the information such as the schedule to the ID card controller 150.

The ID card controller 150 controls the base stations 160a, 160b . . . , and 160n. For example, the ID card controller 150 receives the information such as the schedule from the server 107 and outputs the information to the base stations 160a, 160b . . . , and 160n.

The base stations 160a, 160b . . . , and 160n respectively modulate the information such as the schedule received from the ID card controller 150 and transmit the modulated information to given propagation regions as wireless signals. For example, the base station 160a transmits the wireless signal to the propagation region of a group A shown by broken lines in FIG. 1A. The base station 160b transmits the wireless signal to the propagation region of a group B shown by broken lines in FIG. 1A. The base station 160n transmits the wireless signal to the propagation region of a group N shown by broken lines in FIG. 1A. These pieces of the information which are modulated and transmitted to the propagation regions that are differed for every base station may be selected so as to be made identical with each other or to be made different from each other.

The ID card 105 transmits a signal to any of the base stations 160a, 160b . . . , and 160n. The base station 160a, 160b . . . , or 160n receiving the signal from the ID card 105 outputs it to the ID card controller 150. For example, when wanting to receive information such as newest schedule, the ID card 105 transmits a request signal therefor to any of the base stations 160a, 160b . . . , and 160n. In this embodiment, the base station 160a receives the request signal from the ID card 105 when staying at the propagation region of the group A shown by broken lines in FIG. 1A. The base station 160b receives the request signal from the ID card 105 when staying at the propagation region of the group B shown by broken lines in FIG. 1A. The base station 160n receives the request signal from the ID card 105 when staying at the propagation region of the group N shown by broken lines in FIG. 1A.

The base stations 160a, 160b . . . , and 160n respectively receive the request signal from the ID card 105 and output it to the ID card controller 150. The ID card controller 150 controls the server 107 to output the information such as the newest schedule.

The ID card 105 contains identification information (an identification number, a password and the like) for identify a person and receives the information such as the schedule from the wireless network 103 to display it.

The fixed stations 140a, 140b . . . , and 140m output the information such as the schedule. The identification controller 120 obtains the information such as the schedule from the server 107 and outputs it to the fixed stations 140a, 140b . . . , and 140m. In this embodiment, when being unstable in a propagation state of the wireless signal, the ID card 105 approaches to any of the fixed stations 140a, 140b . . . , and 140m if the ID card 105 cannot receive the information such as the schedule from the wireless network 103, thereby enabling the ID card 105 to receive the information such as the schedule from the fixed station 140a, 140b . . . , or 140m, to which the ID card 105 approaches. For example, the fixed stations 140a, 140b . . . , and 140m perform a short-range wireless communication using radio wave (for example, radio frequency identification (RFID), Bluetooth (trademark) or ZigBee (trademark)) and transmit any information to the ID card 105. The ID card 105 receives the information from, for example, the fixed station 140a, and displays the information on the display device 105a. This allows the ID card 105 to receive and display the information such as the schedule securely even if a fault occurs in the wireless network 103. It is to be noted that although a case where the fixed stations 140a, 140b, . . . and 140m have transmitted the information to the ID card 105 by using the radio wave has been described, the invention is not limited thereto: the information may be transmitted to the ID card 105 by contacting the ID card 105 with the fixed station 140a or the like to connect the ID card 105 to the fixed station 140a using a connector.

The following will describe an operation example of the identification network system 100. For example, an employee holding the ID card 105 faces the ID card 105 against an optical system of the gate station 130A of the identification network 101 when entering the building of his or her firm. The optical system of the gate station 130A scans the cord of the ID card 105 and thus, the gate station 130A reads the identification information (for example, the identification number and the password) from the ID card 105. The gate station 130A outputs the identification number and the password to the identification controller 120.

The identification controller 120 collates the identification number and the password of the employee, which are received from the gate station 130A, with the identification number and the password on the same employee, which are previously registered therein. The identification controller 120 allows the gate of the entrance of the building to open when these identification numbers are agreed with each other and these passwords are agreed with each other. In this moment, the identification controller 120 stores a fact that the employee indicated by the identification information has entered into the building.

Alternatively, the server 107 outputs the notice board, the schedule, the information outside the firm and the like to the base stations 160a, 160b . . . , and 160n through the ID card controller 150. The base stations 160a, 160b . . . , and 160n respectively modulate the information including the schedule and the like to transmit it as the wireless signals to the propagation regions of groups A, B . . . , N, which are shown by the broken lines in FIG. 1A.

As shown in FIG. 1B, the ID card 105 receives the information including the schedule and the like, which is transmitted into each of the propagation regions of groups A, B . . . and N, and displays it.

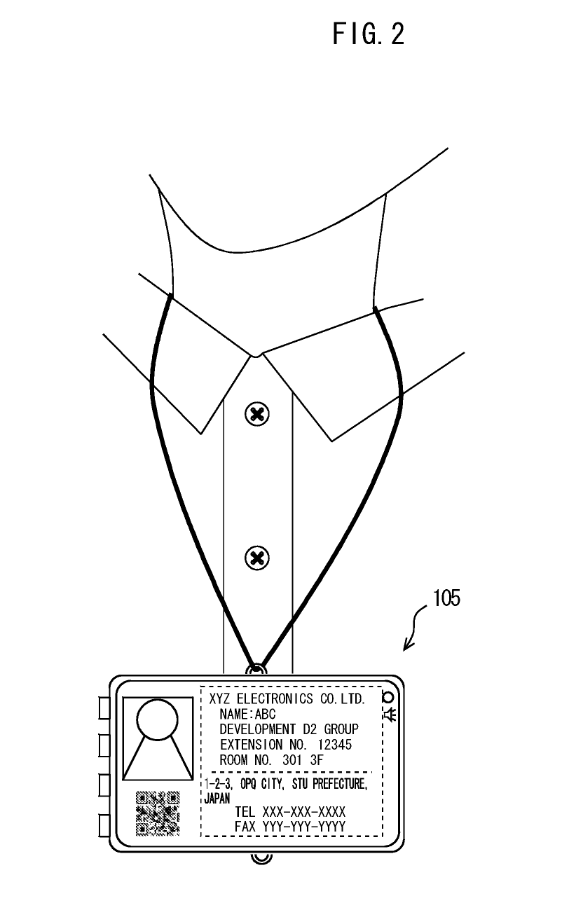

In FIG. 1B, when the employee holding the ID card 105 (for example, he or she holds the ID card 105 with him or her wearing it around his or her neck; see FIG. 2) passes through the gate station 130A and enters the region of group A, the ID card 105 receives the information relative to the notice board from the server 107. The base station 160a sends the information relative to the notice board as the wireless signal. The ID card 105 then displays the information relative to the notice board on its display device 105a.

When the employee holding the ID card 105 enters the region of group B, the ID card 105 receives the information relative to the schedule from the server 107. The base station 160b sends the information relative to the schedule as the wireless signal. The ID card 105 then displays the information relative to the schedule on its display device 105a, which is not shown in FIG. 1B.

When the employee holding the ID card 105 enters the region of group N, the ID card 105 receives the information outside the firm from the server 107. The base station 160n sends the information outside the firm as the wireless signal. The ID card 105 then displays the information outside the firm on its display device 105a, which is not shown in FIG. 1B.

It is to be noted that although a case where the ID card 105 receives the information relative to the notice board or the schedule or the information outside the firm from the base stations 160a, 160b . . . , and 160n respectively as the wireless signals has been described in the above-mentioned embodiment, the ID card 105 may receive the information relative to the notice board or the schedule or the information outside the firm from the fixed stations 140a, 140b . . . , and 140m. This enables the information relative to the notice board or the schedule or the information outside the firm to be received from any of the fixed stations 140a, 140b . . . , and 140m even if the ID card 105 may not receive the wireless signals from the base stations 160a, 160b . . . , and 160n to get the information relative to the notice board or the schedule or the information outside the firm.

Thus, the ID card 105 alone allows for simultaneously having an identification function for identifying the employee, an electronic key function for allowing the employee to enter into or exit from the building and an information terminal function for receiving and displaying information.

When the employee wants to receive the information such as the newest schedule, the ID card 105 transmits a request signal therefor to any of the base stations 160a, 160b . . . , and 160n. The base station receiving the request signal from the ID card 105 outputs the request signal to the server 107 through the ID card controller 150. When the server 107 receives the request signal from the ID card 105, the server 107 outputs the information such as the newest schedule to the ID card controller 150. The ID card controller 150 sends the information such as the newest schedule to the ID card 105 through any of the base stations 160a, 160b . . . , and 160n.

When the employee holding the ID card 105 exits from the building of his or her firm, the employee faces the ID card 105 against an optical system of the gate station 130B of the identification network 101. The optical system of the gate station 130B scans the cord of the ID card 105 and thus, the gate station 130B reads the identification information (for example, the identification number and the password) from the ID card 105. The gate station 130B outputs the identification number and the password to the identification controller 120.

The identification controller 120 receives the identification number and the password of the identification information from the gate station 130B. The identification controller 120 then determines whether or not the identification number of the received identification information corresponds to the identification number, which has been stored in the identification controller 120, of the employee who has been already entered into the building. If the identification number of the received identification information corresponds to the stored identification number, the identification controller 120 collates the identification number and the password of the employee in the identification information received from the gate station 130B with the identification number and the password of the same employee in the identification information previously registered therein. The identification controller 120 thus allows the employee to be exited from the building by opening a gate at the exit of the building when these identification numbers are agreed with each other and these passwords are agreed with each other. In this moment, the identification controller 120 stores a fact that the employee indicated by the identification information has been already exited from the building after his or her entrance has been released.

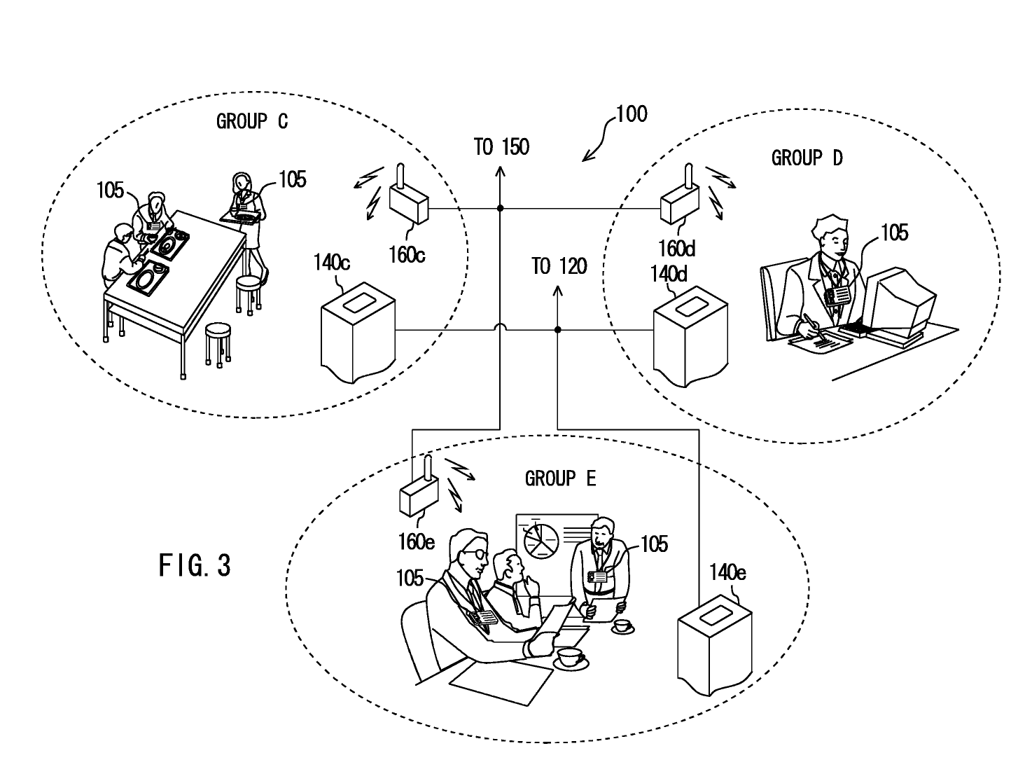

The following will describe another embodiment of the identification network system 100. As shown in FIG. 3, the base stations 160c, 160d and 160e respectively connect the ID card controller 150. The base station 160c is set in a dining hall. The base station 160c modulates the information relative to the notice board or the schedule or the information outside the firm, which is stored in the server 107 and outputted from the server 107 through the ID card controller 150, and transmits the modulated information to a region of group C, which is encircled by the dotted line in FIG. 3, as wireless signals.

The base station 160d is set in an office. The base station 160d modulates the above-mentioned information, which is stored in the server 107 and outputted from the server 107 through the ID card controller 150, and transmits the modulated information to a region of group D, which is encircled by the dotted line in FIG. 3, as wireless signals.

The base station 160e is set in a meeting room. The base station 160e modulates the above-mentioned information, which is stored in the server 107 and outputted from the server 107 through the ID card controller 150, and transmits the modulated information to a region of group E, which is encircled by the dotted line in FIG. 3, as wireless signals.

Thus, by setting the base stations 160c, 160d and 160e in the dining hall, the office and the meeting room, the ID card 105 can receive the information relative to the notice board or the schedule or the information outside the firm from any of the base stations 160c, 160d and 160e surely even if the employee holding the ID card 105 moves, for example, from the dining hall to the office or from the office to the meeting room. Namely, the ID card 105 can receive the information stored in the server 107 even if the employee stays in everywhere in the firm as far as he or she stays in a propagation region of the wireless signals.

It is to be noted that although a case where the ID card 105 receives the information relative to the notice board or the schedule or the information outside the firm from the base stations 160c, 160d and 160e respectively as the wireless signals has been described in the above-mentioned embodiment, the ID card 105 may receive the information relative to the notice board or the schedule or the information outside the firm from any of the fixed stations 140c, 140d and 140e by setting the fixed station 140c in the dining hall, setting the fixed station 140d in the office and setting the fixed station 140e in the meeting room. This enables the information relative to the notice board or the schedule or the information outside the firm to be received from any of the fixed stations 140c, 140d and 140e even if the ID card 105 may not receive the wireless signals from the base stations 160c, 160d and 160e to get the information relative to the notice board or the schedule or the information outside the firm.

The following will describe a configuration of the ID card 105 with reference to FIGS. 4A and 4B. The ID card 105 shown in FIG. 4A is provided with a thin-type display device 105a on a front surface of a housing 105s thereof. The display device 105a is thin and small electronic device such as liquid crystal, electronic paper and organic electroluminescence, which is capable of displaying characters, an image and the like and switching the displays.

A left side 105L of a screen of the display device 105a displays image data such as a photograph 105q of a holder of the ID card 105 and a cord 105p (a bar cord or two-dimensional bar code). A right side 105R of the screen of the display device 105a displays character data of the holder such as a firm to which the holder belongs. Such private information displayed on the right and left sides 105R, 105L of the screen of the display device 105a is registered when each of the employees first has the ID card 105. It is to be noted that the photograph 105q and the cord 105p may be printed on a sheet of paper which is attached to the screen.

The character data displayed on the right side 105R of the screen of the display device 105a is information embedded in the cord 105p. An optical scanning apparatus, not shown, scans the cord 105p so that the information can be printed out or can be output to another display device.

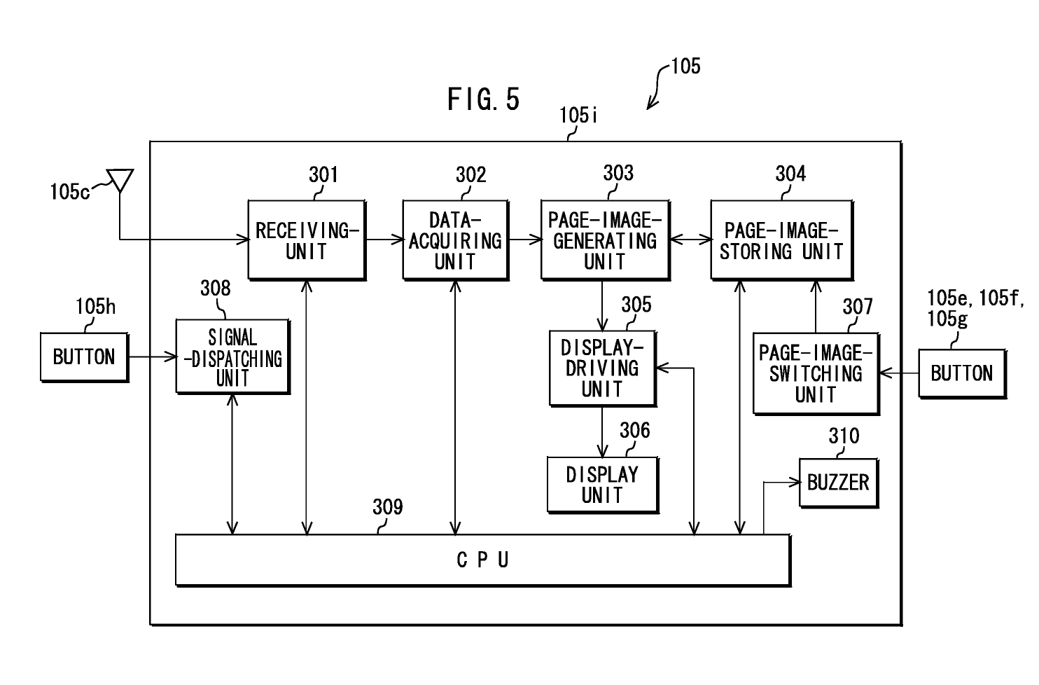

Behind the display device 105a, the print board 105i providing with a driving system for driving the display device 105a and a signal-processing system is installed. The print board 105i will be described with reference to FIG. 5. A button battery is inserted into a portion 105d of the housing 105s to drive the ID card 105. An antenna 105c is installed therein to transmit or receive the information to or from the wireless network 103.

Various kinds of buttons are provided on a side of the ID card 105 for switching the contents displayed on the display device 105a and resetting the ID card 105. For example, a button 105e is used for switching displayed pages on a forward direction thereof. A button 105f is used for switching the displayed pages on a reverse direction thereof. A button 105g is used for resetting the displayed page. A button 105h is used for sending a request from the ID card 105 to the server 107 or for transmitting a radio wave signal. A light-emitting device (LED) 105b is provided on a surface of the ID card 105 for emitting light when the ID card 105 receives the information normally. Any sounding device, for example, a buzzer 310 is also provided on the surface of the ID card 105 for signaling when the ID card 105 does not receive the information normally.

The following will describe a control system in the ID card 105 with reference to FIG. 5. The print board 105i of the ID card 105 mounts a receiving unit 301, a data-acquiring unit 302, a page-image-generating unit 303, a page-image-storing unit 304, a display-driving unit 305, a display unit 306, a page-image-switching unit 307, a signal-dispatching unit 308 and CPU 309. The print board 105i of the ID card 105 also mounts the buzzer 310 that connects the CPU 309.

The receiving unit 301 connects the antenna 105c and receives the information such as a schedule from the wireless network 103 shown in FIG. 1A through the antenna 105c.

The data-acquiring unit 302 acquires the data on the schedule or the like from the receiving unit 301 and outputs the data to the page-image-generating unit 303.

The page-image-generating unit 303 is an example of a generating unit. The page-image-generating unit 303 generates image data (made of display pixels of n row and m column) for each page and outputs the image data to the page-image-storing unit 304.

The page-image-storing unit 304 is an example of a storing unit. The page-image-storing unit 304 receives the image data on the pages from the page-image-generating unit 303 and stores them.

The page-image-generating unit 303 also outputs the image data to be stored in the page-image-storing unit 304 to the display-driving unit 305.

The display-driving unit 305 receives the image data for each page from the page-image-generating unit 303 and drives the display unit 306 based on the image data for each page.

The display unit 306 displays an image for each page on its screen.

The page-image-switching unit 307 switches output of the page-image-storing unit 304, namely, the page images stored in the page-image-storing unit 304 based on an operation signal from any of the buttons 105e, 105f and 105g. The page-image-storing unit 304 outputs the switched page image to the page-image-generating unit 303. The page-image-generating unit 303 receives the switched page image from the page-image-storing unit 304 and outputs it to the display-driving unit 305. It is to be noted that the page-image-switching unit 307 and the buttons 105e, 105f and 105g constitute a switching portion.

Thus, by operating the buttons 105e, 105f and 105g, it is possible to successively switch the page images to be displayed on the screen of the display unit 306. For example, by operating the button 105e, it is possible to switch the displayed page images on a forward direction thereof. By operating the button 105f, it is possible to switch the displayed page images on a reverse direction thereof. By operating the button 105g, it is possible to reset the displayed page image. Further, if a menu page image is provided, the displayed page image can be switched to such a menu page image by operating any of the buttons 105e, 105f and 105g, thereby allowing a user to select any contents in a menu guide.

The signal-dispatching unit 308 dispatches the request signal to the base stations 160a, 160b . . . , and 160n, which are shown in FIG. 1A, based on an operation signal from the button 105h. In this embodiment, the employee holding the ID card 105 operates the button 105h when he or she wants to receive the information such as the newest schedule or when any information display does not succeed so that the ID card 105 dispatches the request signal to the base stations 160a, 160b . . . , and 160n by the signal-dispatching unit 308. This enables the ID card 105 to receive the information such as the newest schedule. If the ID card 105 fails to receive the information when the signal-dispatching unit 308 dispatches the request signal to the base stations 160a, 160b . . . , and 160n, the buzzer 310 sounds for signaling the employee holding the ID card 105 that it fails to receive the information. The CPU 309 controls the data-acquiring unit 302, the page-image-storing unit 304, the display-driving unit 305 and the signal-dispatching unit 308.

Although it has described in this embodiment that the buzzer 310 sounds when the ID card 105 fails to receive the information, the invention is not limited thereto: the buzzer 310 may sound when the ID card 105 receives the information. This enables the employee holding the ID card 105 to recognize the information by his or her the sense of hearing.

The following will describe an operation example of the control system in the ID card 105.

The receiving unit 301 receives the information such as a schedule from the base stations 160a, 160b . . . , and 160n shown in FIG. 1A through the antenna 105c shown in FIG. 5. The data-acquiring unit 302 acquires the data on the schedule or the like from the receiving unit 301 and outputs the data to the page-image-generating unit 303. The page-image-generating unit 303 generates image data (on the page image) for each page from the data on the schedule or the like and the page-image-storing unit 304 then stores the page images.

The page-image-switching unit 307 switches output of the page-image-storing unit 304, namely, the page images stored in the page-image-storing unit 304. The page-image-generating unit 303 receives the page image, which is stored in the page-image-storing unit 304 and is switched by the page-image-switching unit 307, from the page-image-storing unit 304 and outputs it to the display-driving unit 305. The display-driving unit 305 drives the display unit 306 to display the page image output from the page-image-generating unit 303 on its screen. Thus, it is possible to successively switch the page images to be displayed on the screen of the display unit by operating the buttons 105e, 105f and 105g.

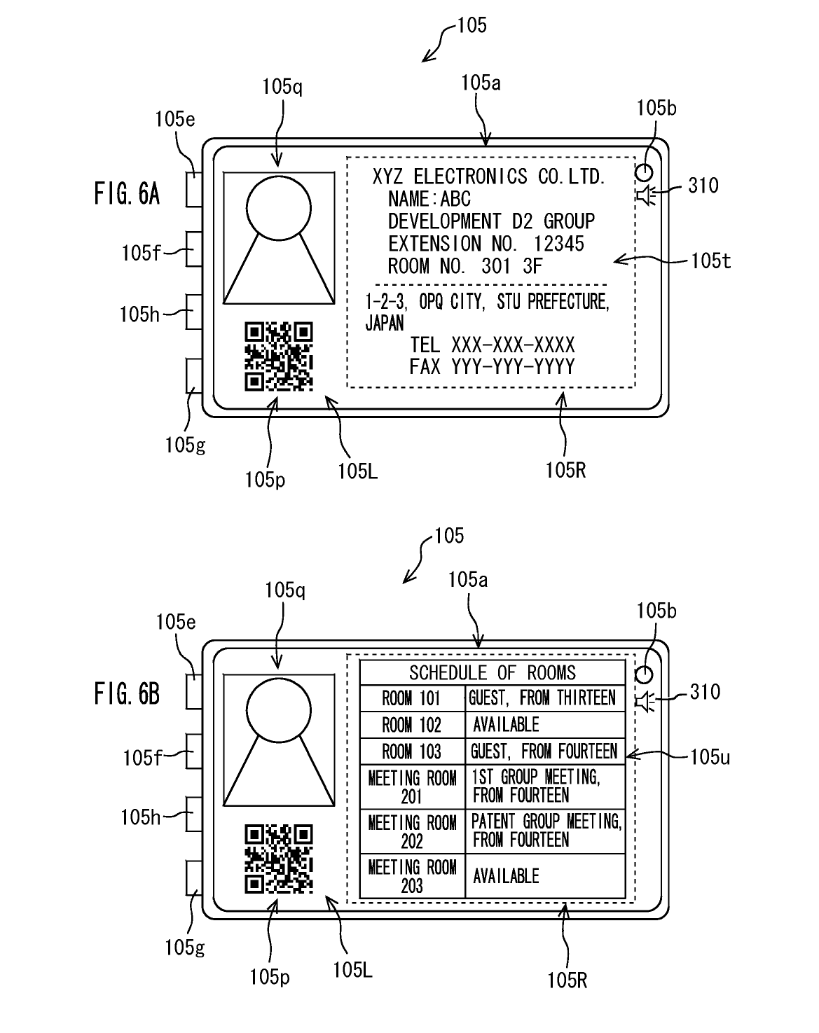

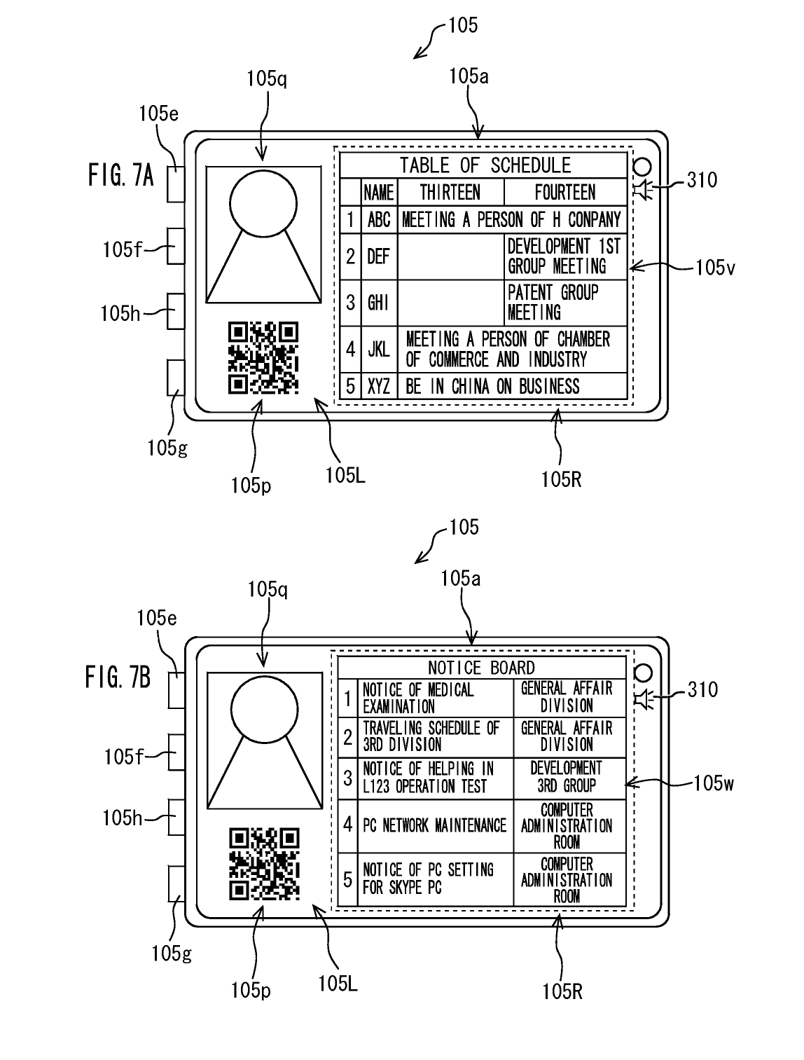

The following will describe a display example of the ID card 105 (for an employee) with reference to FIGS. 6A, 6B, 7A and 7B.

The left side 105L of the screen of the display device 105a of the ID card 105 shown in FIG. 6A displays image data such as the photograph 105q of the holder of the ID card 105 and the cord 105p. The right side 105R of the screen of the display device 105a displays the holder's private information 105t including information such as his or her name and a firm to which he or she belongs. Such private information 105t displayed is stored in the page-image-storing unit 304 of the ID card 105. In this embodiment, when each of the employees first has the ID card 105, the private information 105t to be displayed is registered in the page-image-storing unit 304 of the ID card 105. When registering the private information 105t in the page-image-storing unit 304, wireless signal may be used to transmit the data or any cord may connect the ID card 105 to transmit the data. For example, when setting an image indicating the private information 105t as an initial image and operating the button 105g for resetting, the right side 105R of the screen of the display device 105a displays the holder's private information 105t as shown in FIG. 6A. This enables the holder of the ID card 105 to return the image indicating the private information 105t directly from other images, which will be described in later.

The left side 105L of the screen of the display device 105a of the ID card 105 shown in FIG. 6B displays image data such as the photograph 105q of the holder of the ID card 105 and the cord 105p. The right side 105R of the screen of the display device 105a displays a room schedule image 105u indicating a use schedule of rooms.

The room schedule image 105u is displayed by operating the buttons 105e, 105f. For example, by operating the button 105e for switching the page images on its forward direction thereof, the image indicating the private information 105t shown in FIG. 6A is switched to the room schedule image 105u. The room schedule image 105u includes any display contents, for example, “The room 101 will be used for a guest from thirteen.” and “The meeting room 203 is available”. Thus, the ID card 105 enables the ID card's holder to confirm the use schedule of each of the rooms easily on an almost real-time basis without carrying any information terminal such as a notebook personal computer.

The information to be displayed in the room schedule image 105u is transmitted from the server 107 shown in FIG. 1A to the ID card 105 through the base stations 160a, 160b . . . , and 160n, and is stored in the page-image-storing unit 304 of the ID card 105. A period of time when thee server 107 transmits the information to be displayed in the room schedule image 105u is set so as to be from some minutes to about one hour.

The left side 105L of the screen of the display device 105a of the ID card 105 shown in FIG. 7A displays image data such as the photograph 105q of the holder of the ID card 105 and the cord 105p. The right side 105R of the screen of the display device 105a displays a table-of-schedule image 105v indicating a schedule of each employee.

The table-of-schedule image 105v is displayed by operating the buttons 105e, 105f. For example, by operating the button 105e for switching the page images on its forward direction thereof, the room schedule image 105u shown in FIG. 6B is switched to the table-of-schedule image 105v. The table-of-schedule image 105v includes any display contents, for example, “Mr. ABC will meet a person of H company from thirteen.” and “Mr. XYZ is in China on business”. Thus, the ID card 105 enables the ID card's holder to confirm the schedule of each employee easily on an almost real-time basis without carrying any information terminal such as a notebook personal computer.

The information to be displayed in the table-of-schedule image 105v is transmitted from the server 107 shown in FIG. 1A to the ID card 105 through the base stations 160a, 160b . . . , and 160n, and is stored in the page-image-storing unit 304 of the ID card 105. A period of time when the server 107 transmits the information to be displayed in the table-of-schedule image 105v is set so as to be from some minutes to about one hour.

The left side 105L of the screen of the display device 105a of the ID card 105 shown in FIG. 7B displays image data such as the photograph 105q of the holder of the ID card 105 and the cord 105p. The right side 105R of the screen of the display device 105a displays a notice board image 105w indicating contents contributed to the notice board.

The notice board image 105w is displayed by operating the buttons 105e, 105f. For example, by operating the button 105e for switching the page images on its forward direction thereof, the table-of-schedule image 105v shown in FIG. 7A is switched to the notice board image 105w. The notice board image 105w includes any display contents, for example, “Notice of a medical examination from General Affair Division” and “Notice of maintenance of PC network from Computer Administration Room”. Thus, the ID card 105 enables the ID card's holder to confirm the contents contributed to the notice board easily on an almost real-time basis without carrying any information terminal such as a notebook personal computer.

The information to be displayed in the notice board image 105w is transmitted from the server 107 shown in FIG. 1 to the ID card 105 through the base stations 160a, 160b . . . , and 160n, and is stored in the page-image-storing unit 304 of the ID card 105. A period of time when the server 107 transmits the information to be displayed in the notice board image 105w is set so as to be from some minutes to about one hour.

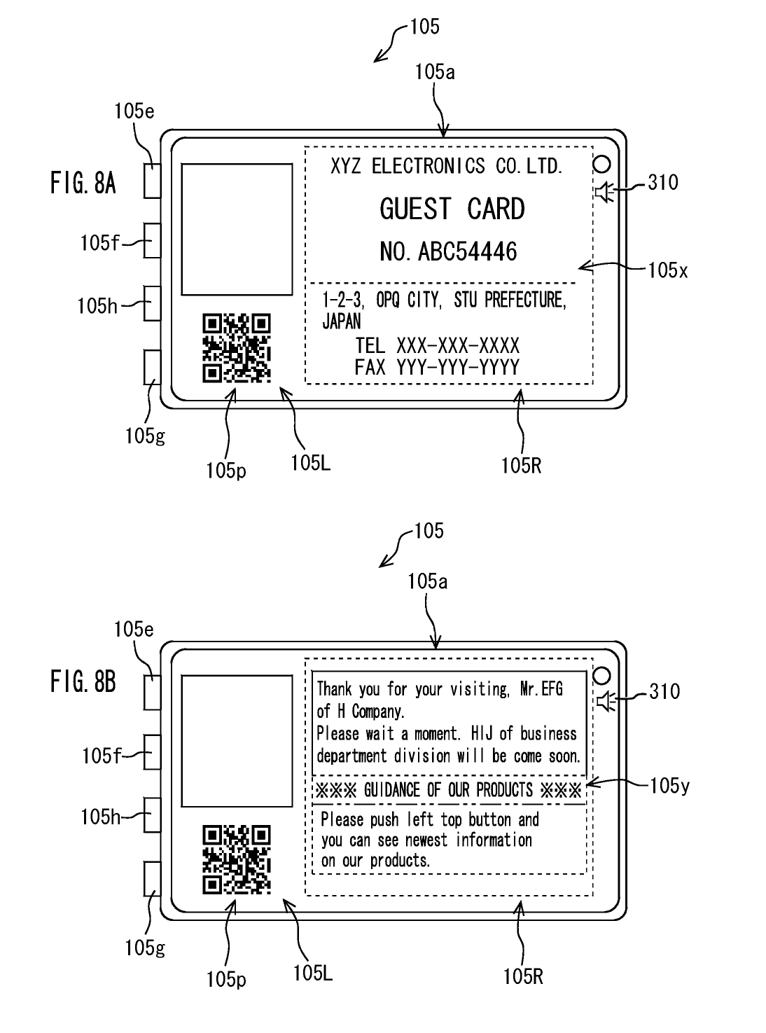

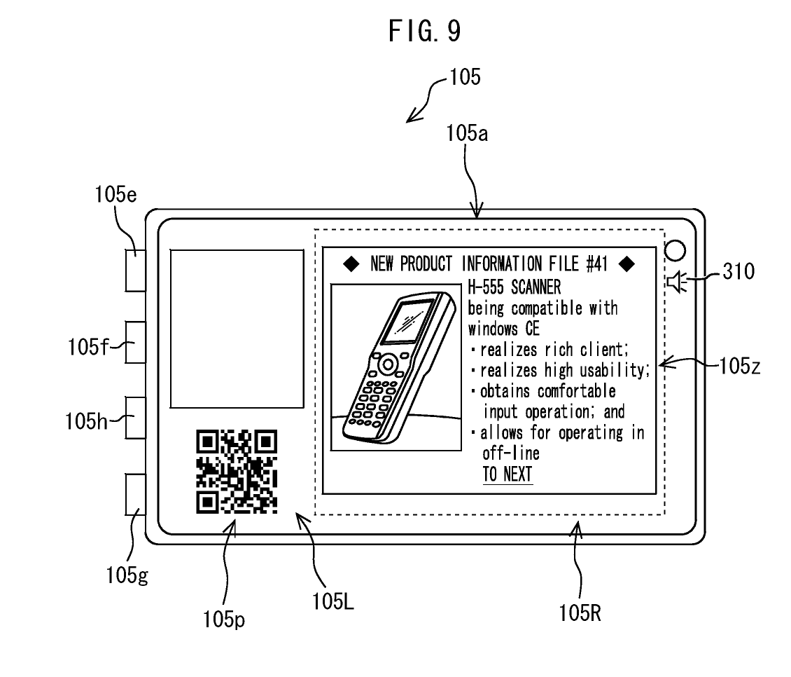

The following will describe a display example of the ID card 105 (for a guest) with reference to FIGS. 8A, 8B and 9.

The left side 105L of the screen of the display device 105a of the ID card 105 shown in FIG. 8A displays image data such as the cord 105p. The right side 105R of the screen of the display device 105a displays a guest initial image 105x indicating a guest number or the like. The guest initial image 105x is stored in the page-image-storing unit 304 of the ID card 105. In this embodiment, when a guest first visits a firm to hold the ID card 105, the information indicating the guest initial image 105x to be displayed is registered in the page-image-storing unit 304 of the ID card 105. When setting the guest initial image 105x as an initial image and operating the button 105g for resetting, the right side 105R of the screen of the display device 105a displays the guest initial image 105x as shown in FIG. 8A. This enables the guest to return the guest initial image 105x directly from other images, which will be described in later.

The left side 105L of the screen of the display device 105a of the ID card 105 shown in FIG. 8B displays image data such as the cord 105p. The right side 105R of the screen of the display device 105a displays a standby image 105y. The standby image 105y is displayed by operating the buttons 105e, 105f. For example, by operating the button 105e for switching the page images on its forward direction thereof, the guest initial image 105x shown in FIG. 8A is switched to the standby image 105y. The standby image 105y includes a message, for example, “HIJ of the business department division will be come soon.” and a message of recommending the guest to see guidance information of products of the firm. Thus, the ID card 105 enables the guest to get any useful information easily.

The information to be displayed in the standby image 105y is transmitted from the server 107 shown in FIG. 1A to the ID card 105 through the base stations 160a, 160b . . . , and 160n, and is stored in the page-image-storing unit 304 of the ID card 105. A period of time when the server 107 transmits the information to be displayed in the standby image 105y is set so as to be from some minutes to several tens of minutes.

The left side 105L of the screen of the display device 105a of the ID card 105 shown in FIG. 9 displays an image such as the cord 105p. The right side 105R of the screen of the display device 105a displays a product-presentation image 105z. The product-presentation image 105z is switched from the standby image 105y shown in FIG. 8B by operating the button 105e for switching the page images on its forward direction thereof, and displayed. The product-presentation image 105z includes contents of a new product of the firm. Thus, the ID card 105 can present information on the new product to the guest easily, thereby enabling the ID card 105 to be utilized as an advertising medium.

The information to be displayed in the product-presentation image 105z is transmitted from the server 107 shown in FIG. 1A to the ID card 105 through the base stations 160a, 160b . . . , and 160n, and is stored in the page-image-storing unit 304 of the ID card 105. A period of time when the server 107 transmits the information to be displayed in the product-presentation image 105z is set so as to be from some minutes to about one hour.

Thus, according to this embodiment of the invention, the ID card 105 has the identification information for identifying a person and displays the information received from the wireless network 103. The identification network system 100 reads the identification information from the identification card to suitably identify the person. Thus, the ID card 105 functioning as a card of identity, as an electronic key and as an information terminal can identify the person and receive the information to display it. The ID card 105 is rewritable so that even if the person leaves his or her firm, for example, he or she is retired, the ID card 105 can be used for another person.

According to this embodiment, it is possible to read any necessary information such as the notice board and the schedule if the person has the ID card 105 even when the person does not carry a notebook personal computer or does not stay near a desktop personal computer. The person who has entered into the building of the firm has been identified by the gate station 130A so that his or her ID card 105 can receive any necessary information at any time.

If no operation is performed on the ID card 105, the image on the private information 105t shown in FIG. 6A is displayed. Such image is displayed as a name card indicating the belonging in the firm. When operating the button 105e, 105f or 105g, the image displayed on the screen is switched to the room schedule image 105u shown in FIG. 6B, the table-of-schedule image 105v shown in FIG. 7A or the notice board image 105w shown in FIG. 7B. Although, in this embodiment, a case where the initial image has been switched to three other images has been shown, it is possible to skip unnecessary images to any necessary image by setting the menu image without displaying all of the switchable images when there are many images.

The ID card 105 for the guest as shown in FIG. 8A is handed to the guest when he or she visits the firm. When operating the button 105e or the like of the ID card 105 for the guest, the standby image 105y indicating a greeting or the like as shown in FIG. 8B is displayed. When further operating the button 105e or the like of the ID card 105 for the guest, the product-presentation image 105z shown in FIG. 9 is displayed so as to be able to read any information on new products while a period of the waiting time or the meeting time.

### [Variations]

The following will describe variations of the above-mentioned identification network system 100. The image may be displayed on the ID card 105 with the image being made different from each other for every group A, B . . . , or N of the base station 160a, 160b . . . , or 160n. For example, if the propagation region of the group A belongs to the propagation region of the development section of the firm, the base station 160a transmits any technical information that is necessary for a development staff to the propagation region of the group A. If the propagation region of the group B belongs to the propagation region of the business department section of the firm, the base station 160b transmits any information that is necessary for a business department staff to the propagation region of the group B. This enables the development staff to receive only his or her necessary technical information when he or she stays in the propagation region of the group A. This also enables the business department staff to receive only his or her necessary information when he or she stays in the propagation region of the group B.

In addition to the case where the base stations transmit the different pieces of information for every propagation region, identification numbers may be set to each section of the firm such as the development section and the business department section and the base stations may transmit the information based on the identification numbers. For example, the identification number, 0001, is set to the development section and the identification number, 0002, is set to the business department section. In the variations, the base stations 160a, 160b . . . , and 160n transmit the information set of the identification number, 0001, and any information that is necessary for the development staff. The identification number, 0001, indicating the development section is set in the ID card 105 of the development staff and the ID card 105 of the development staff receives the information only when the identification number transmitted from the base stations 160a, 160b . . . , and 160n agrees with the identification number, 0001. This enables the development staff to receive only his or her necessary information.

Further, the base stations 160a, 160b . . . , and 160n may transmit different pieces of information to different persons. For example, the base stations 160a, 160b . . . , and 160n transmit the information set of the identification number of the person and the information that is necessary for the person. The identification number of the person is set in the ID card 105 of the person and the ID card 105 of the person receives the information only when the identification number transmitted from the base stations 160a, 160b . . . , and 160n agrees with the identification number of the person. This enables the person to receive only his or her necessary information.

Each of the fixed stations 140a, 140b . . . and 140m mounts a cord-scanning apparatus that reads the identification number of the person by scanning the cord in the ID card 105. The fixed station mounting the cord-scanning apparatus that reads the identification number of the person may request the information corresponding to the identification number of the person to the server 107 and it may receive such information from the server 107 and transmit the information to the ID card 105.

A storage box for storing the ID card 105 maybe set which is used when the person exits from the building of the firm. In this case, the identification network system 100 is controlled so that the gate opens by throwing the ID card 105 to the storage box through a window of the storage box, not by detecting the exit of the person by means of the gate station 130B.

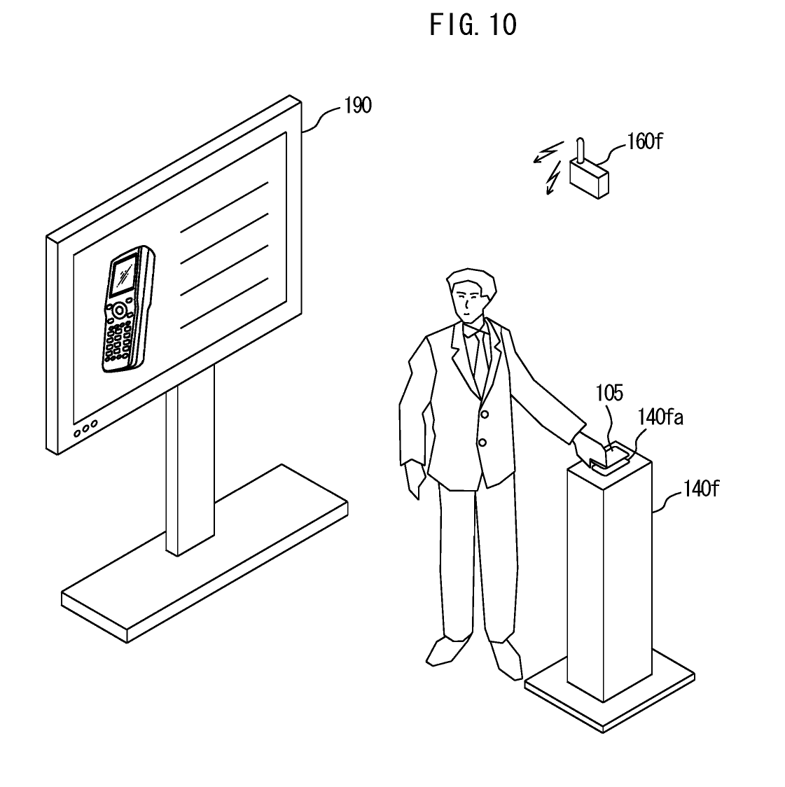

Although a case where the ID card 105 has been used as the employee identification card has been described, the invention is not limited thereto: the ID card 105 may be used for other purposes. For example, it is available for any events in an exhibition or a museum. In this case, the base stations 160a, 160b . . . , and 160n respectively transmit the different pieces of information. For example, in the exhibition, as shown in FIG. 10, the base station 160f and the fixed station 140f transmit any information on an explanation of products of X Company, which is shown in display equipment 190. If the ID card 105 of the employee stays in a propagation region of wireless signal (on the information) transmitted from the base station 160f when the ID card 105 receives any information from the base station 160f, the ID card 105 can receive the corresponding wireless signal. When the ID card 105 receives any information from the fixed station 140f, a transmitting portion 140fa reads the cord 105p of the ID card 105 by approaching the ID card 105 to the transmitting portion 140fa. The server 107 connected to the fixed station 140f then outputs the information and the fixed station 140f transmits the information to the ID card 105 so that the ID card 105 can receive the corresponding information.

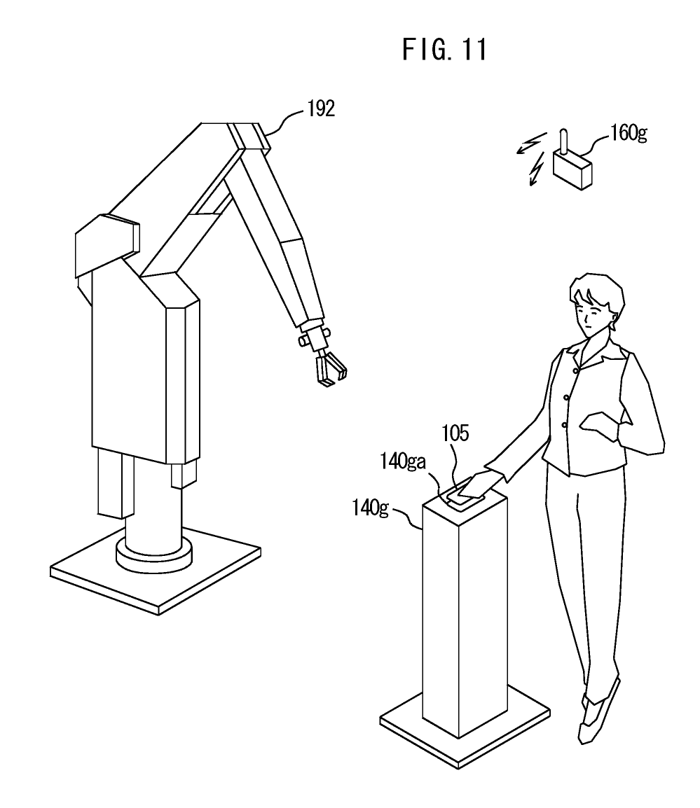

Further, in another booth of the exhibition as shown in FIG. 10, as shown in FIG. 11, the base station 160g and the fixed station 140g transmit any driving information for driving a robot 192 of Y Company. If the ID card 105 of the employee stays in a propagation region of wireless signal (on the information) transmitted from the base station 160g when the ID card 105 receives any information from the base station 160g, the ID card 105 can receive the corresponding wireless signal. When the ID card 105 receives any information from the fixed station 140g, a transmitting portion 140ga reads the cord 105p of the ID card 105 by approaching the ID card 105 to the transmitting portion 140ga. The server 107 connected to the fixed station 140g then outputs the information and the fixed station 140g transmits the information to the ID card 105 so that the ID card 105 can receive the corresponding information. In the museum, the base station 160a transmits any information on an explanation of an exhibit X. The base station 160b transmits any information on a historical background of an exhibit Y. The ID card 105 receives pieces of the information. Thus, the ID card 105 can receive the different pieces of information from the base stations to display them. When exiting, a gate opens by putting the ID card 105 into a storage box.

Although a case where the cord has been scanned in the gate station 130A or 130B to obtain the identification information (identification number and password) has been described, this invention is not limited thereto: the identification information may be obtained by using the short-range wireless communication using radio wave or the like (for example, radio frequency identification (RFID), Bluetooth (trademark) or ZigBee (trademark)).

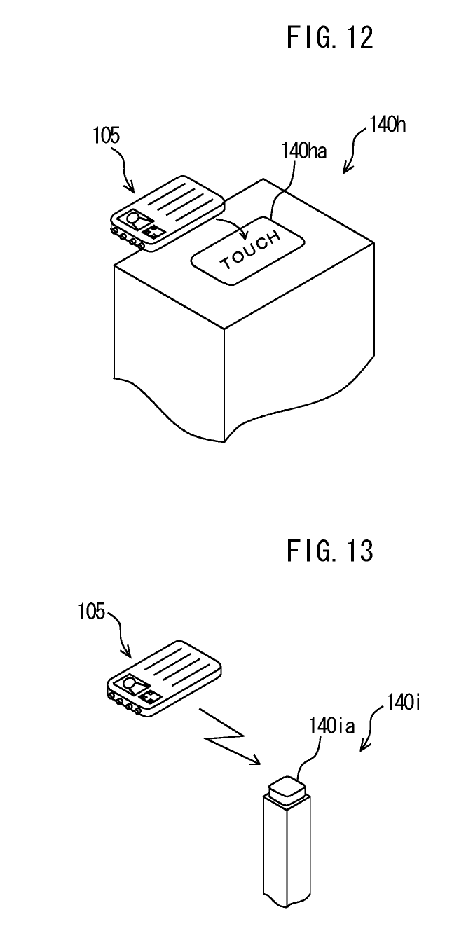

When the identification information is obtained using RFID, the fixed station 140h contains a transmitting-and-receiving portion 140ha for transmitting and receiving the identification information, as shown in FIG. 12, which is connected to the identification controller 120 and the server 107, shown in FIG. 1A. When the ID card 105 contacts or approaches the transmitting-and-receiving portion 140ha, the ID card 105 outputs the identification information so that the fixed station 140h receives the corresponding identification information through the transmitting-and-receiving portion 140ha. The fixed station 140h transmits the received identification information to the identification controller 120. The identification controller 120 determines whether or not the received identification information is registered in the server 107.

The identification controller 120 transmits the information relative to the notice board or the schedule, the information outside the firm or the like to the fixed station 140h if the received identification information is registered in the server 107. The fixed station 140h then transmits to the ID card 105 the information transmitted from the identification controller 120 through the transmitting-and-receiving portion 140ha. The identification controller 120 does not transmit the information to the fixed station 140h if the received identification information is not registered in the server 107.

When the identification information is obtained using Bluetooth (trademark), ZigBee (trademark) or the like, the fixed station 140h contains a transmitting-and-receiving portion 140ia for transmitting and receiving the identification information, as shown in FIG. 13, which is connected to the identification controller 120 and the server 107, shown in FIG. 1A. When the ID card 105 approaches the transmitting-and-receiving portion 140ia (but the ID card 105 is not required to contact the transmitting-and-receiving portion 140ha in the fixed station 140h shown in FIG. 12), the ID card 105 outputs the identification information so that the fixed station 140i receives the corresponding identification information through the transmitting-and-receiving portion 140ia. The fixed station 140i transmits the received identification information to the identification controller 120. The identification controller 120 determines whether or not the received identification information is registered in the server 107.

The identification controller 120 transmits the information relative to the notice board or the schedule, the information outside the firm or the like to the fixed station 140i if the received identification information is registered in the server 107. The fixed station 140i then transmits to the ID card 105 the information transmitted from the identification controller 120 through the transmitting-and-receiving portion 140ia. The identification controller 120 does not transmit the information to the fixed station 140i if the received identification information is not registered in the server 107.

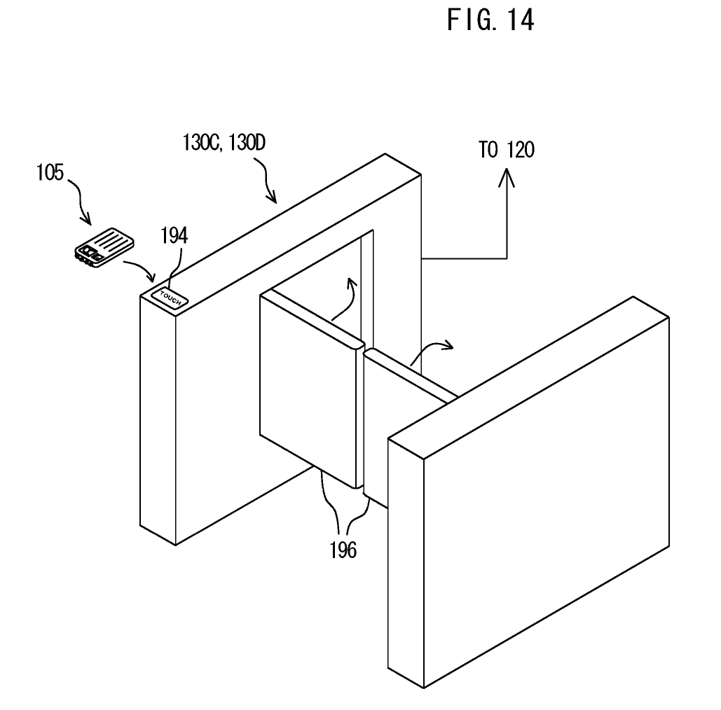

In these cases, the identification network 101 is provided with a gate station 130C or 130D which receives radio wave signals and read identification information instead of the gate station 130A or 130B which reads the information by optical system thereof. The gate station 130C or 130D is used as an example of receiving unit. The identification controller 120 controls an entrance or exit of the person into or from a building of a firm by using the identification information read by the gate station 130C or 130D. For example, as shown in FIG. 14, the ID card 105 outputs the identification information to a transmitting-and-receiving portion 194 provided on the gate station 130C or 130D using radio wave signal and the transmitting-and-receiving portion 194 reads the identification information from the received radio wave signal. The identification controller 120 collates the identification number and the password on the person in the identification information read by the transmitting-and-receiving portion 194 with an identification number and a password on the same person in the identification information previously registered therein. The identification controller 120 thus allows the person to be entered into the building by opening a gate 196 at the entrance or the exit of the building when these identification numbers are agreed with each other and these passwords are agreed with each other.

The ID card according to this invention is also applicable to a credit card or a stored-value card. When a user uses the ID card according to this invention in a store, the ID card communicates with any terminal equipment in the store using the above-mentioned short-range wireless communication such as RFID, Bluetooth (trademark) or ZigBee (trademark).

When the ID card is applied to such an application, the ID card may have a monetary value, which is similar to a tradeable coupon. The ID card stores any private information so that if the ID card is stolen or is missing, any serious damage may occur. It is desirable to improve a security of the ID card by making the ID card have a function to determine whether or not a holder of the ID card is a real owner of the ID card.

The following will describe two methods for improving a security of the ID card.

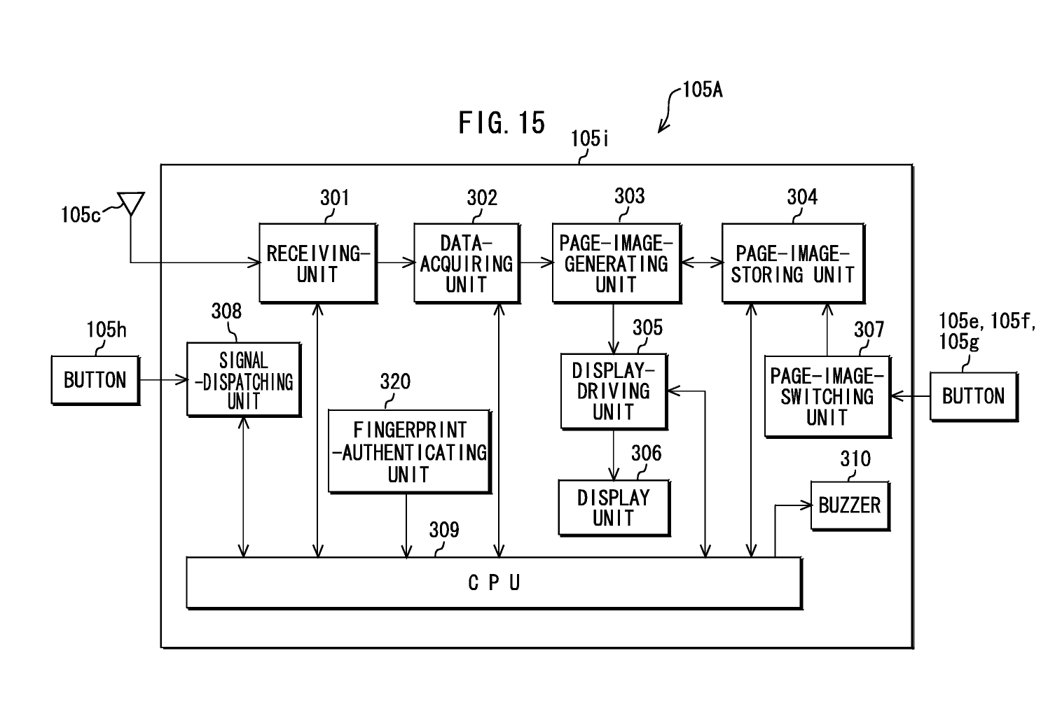

First, an ID card 105A that is provided with a fingerprint-authenticating unit 320 in addition to the ID card 105. Like reference characters and numbers refer to like elements of the above-mentioned embodiment, explanation of which will be omitted. As shown in FIG. 15, the ID card 105A contains a print board 105i. The print board 105i mounts a receiving unit 301, a data-acquiring unit 302, a page-image-generating unit 303, a page-image-storing unit 304, a display-driving unit 305, a display unit 306, a page-image-switching unit 307, a signal-dispatching unit 308, CPU 309, a buzzer 310 and the fingerprint-authenticating unit 320. The fingerprint-authenticating unit 320 authenticates a fingerprint (for example, a fingerprint of the real owner of the ID card 105A) registered on the ID card 105A.

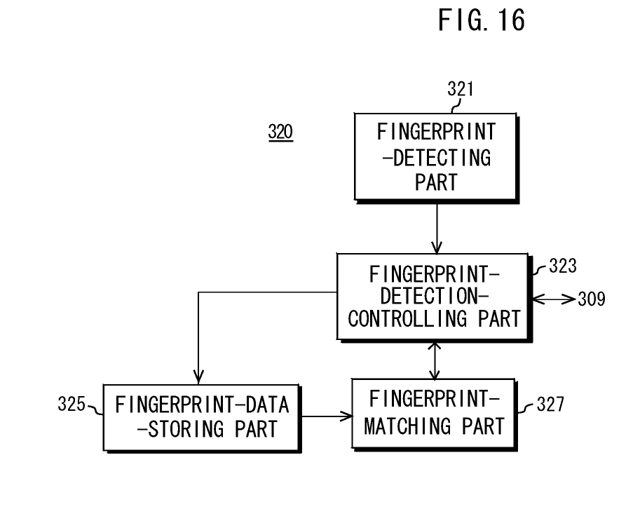

As shown in FIG. 16, the fingerprint-authenticating unit 320 contains a fingerprint-detecting part 321, a fingerprint-detection-controlling part 323, a fingerprint-data-storing part 325 and a fingerprint-matching part 327. The fingerprint-detecting part 321 is formed on, for example, a surface of the display device 105Aa of the ID card 105A. The fingerprint-detecting part 321 is connected to the fingerprint-detection-controlling part 323. When the real owner of the ID card 105A contacts the fingerprint-detecting part 321 by his or her finger, the fingerprint-detection-controlling part 323 reads a fingerprint of the contacted finger of the real owner of the ID card 105A. The fingerprint-detection-controlling part 323 then registers the read fingerprint on the fingerprint-data-storing part 325 as fingerprint data. Such fingerprint data is not allowed to be changed if the fingerprint is once registered on the fingerprint-data-storing part 325.

To the fingerprint-detection-controlling part 323, the fingerprint-matching part 327 is also connected. The fingerprint-matching part 327 determines whether or not a fingerprint read by the fingerprint-detecting part 321 is identical to the fingerprint registered on the fingerprint-data-storing part 325 as the fingerprint data (namely, it performs matching process). To the fingerprint-detection-controlling part 323, the CPU 309 shown in FIG. 15 is further connected. The fingerprint-detection-controlling part 323 outputs a result of the matching process of the fingerprints to the CPU 309.

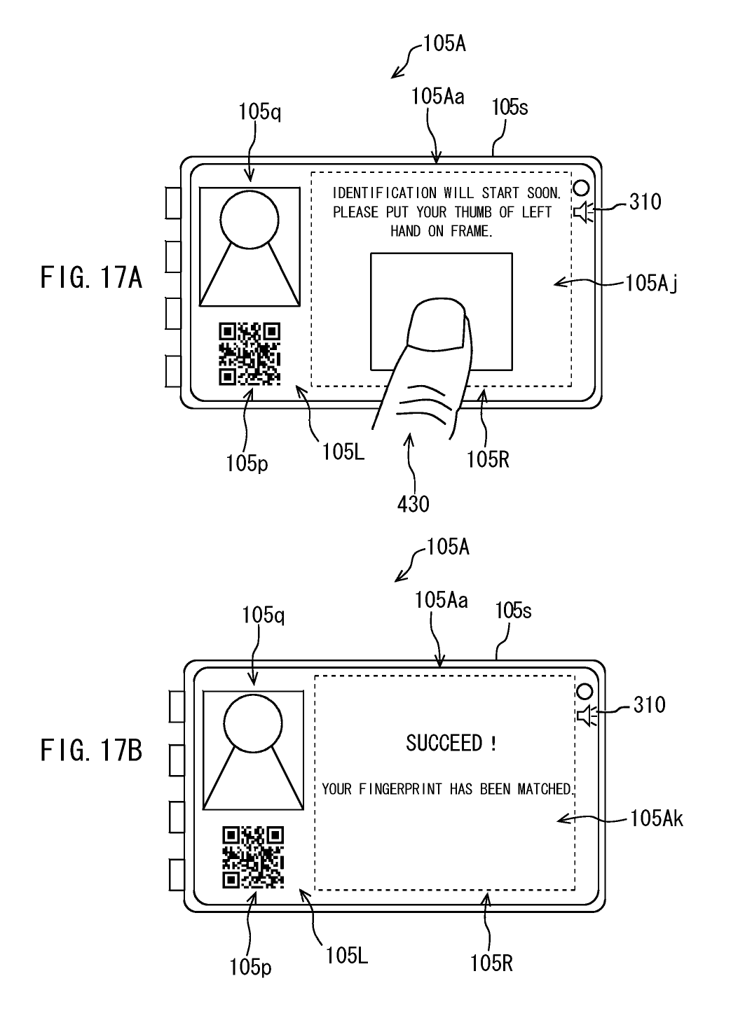

For example, the ID card 105A is powered on, the CPU 309 controls the display device 105Aa to display thereon a fingerprint-authenticating request screen 105Aj, as shown in FIG. 17A, displaying a message, for example, “Identification will start soon. Please put your thumb of left hand on a frame.” After the fingerprint-authenticating request screen 105Aj is displayed on the display device 105Aa, a holder of the ID card 105A puts his or her thumb 430 of left hand on the frame in the fingerprint-authenticating request screen 105Aj and then, the fingerprint-detecting part 321 reads the fingerprint of the thumb 430. The fingerprint-detection-controlling part 323 outputs the fingerprint read by the fingerprint-detecting part 321 to the fingerprint-matching part 327 as the fingerprint data. The fingerprint-matching part 327 determines whether or not the fingerprint data outputted from the fingerprint-detection-controlling part 323 is identical to the fingerprint data registered on the fingerprint-data-storing part 325 (namely, it performs matching process).

When the fingerprint-matching part 327 determines that the fingerprint data outputted from the fingerprint-detection-controlling part 323 is identical to the fingerprint data registered on the fingerprint-data-storing part 325, the fingerprint-matching part 327 outputs fingerprint-matching information indicating that items of the fingerprint data are matched to the CPU 309 through the fingerprint-detection-controlling part 323. When the CPU 309 receives the fingerprint-matching information from the fingerprint-matching part 327, the CPU 309 controls the display device 105Aa to display thereon a fingerprint-matching confirmation screen 105Ak, as shown in FIG. 17B, displaying a message, for example, “SUCCEED! Your fingerprint has been matched.” When the fingerprint data are matched, the ID card 105A is available. When the fingerprint-matching part 327 determines that the fingerprint data outputted from the fingerprint-detection-controlling part 323 is not identical to the fingerprint data registered on the fingerprint-data-storing part 325, the fingerprint-matching part 327 outputs fingerprint-unmatched information indicating that items of the fingerprint data are not matched to the CPU 309 through the fingerprint-detection-controlling part 323. The CPU 309 controls the display device 105Aa to display thereon a fingerprint-unmatched confirmation screen 105 displaying a message, for example, “Your fingerprint has not been matched.” When items of the fingerprint data are not matched, the ID card 105B is unavailable.

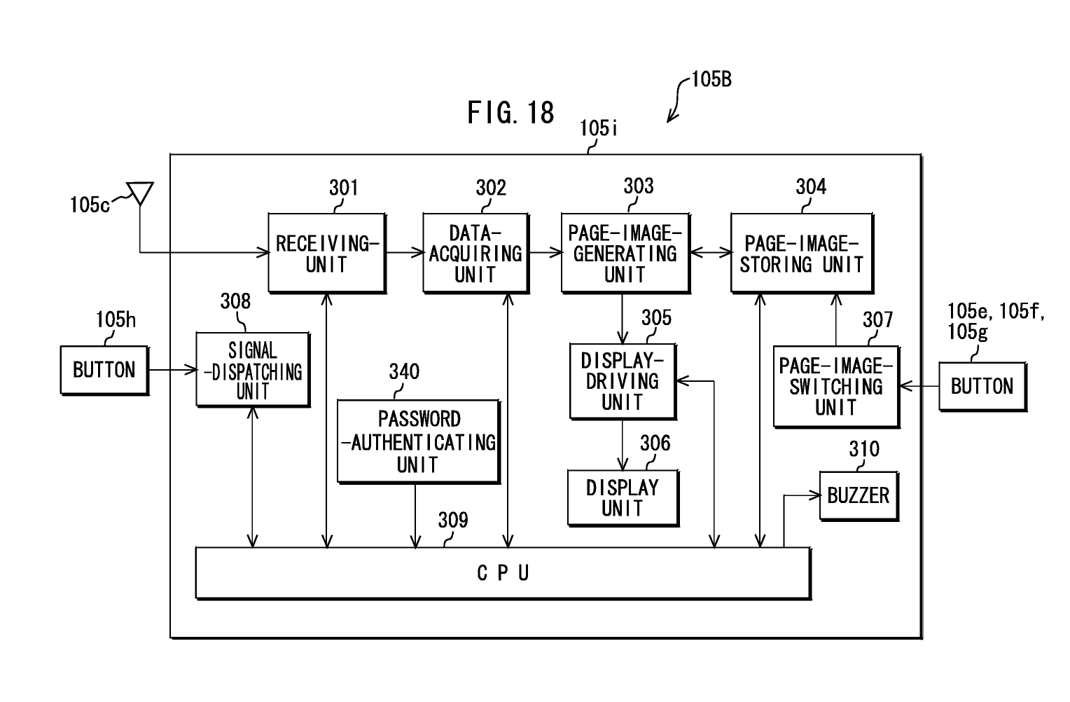

Second, an ID card 105B that is provided with a password-authenticating unit 340 in addition to the ID card 105. Like reference characters and numbers refer to like elements of the above-mentioned embodiment, explanation of which will be omitted. As shown in FIG. 18, the ID card 105B contains a print board 105i. The print board 105i mounts a receiving unit 301, a data-acquiring unit 302, a page-image-generating unit 303, a page-image-storing unit 304, a display-driving unit 305, a display unit 306, a page-image-switching unit 307, a signal-dispatching unit 308, CPU 309, a buzzer 310 and the password-authenticating unit 340. The password-authenticating unit 340 authenticates a password registered on the ID card 105B.

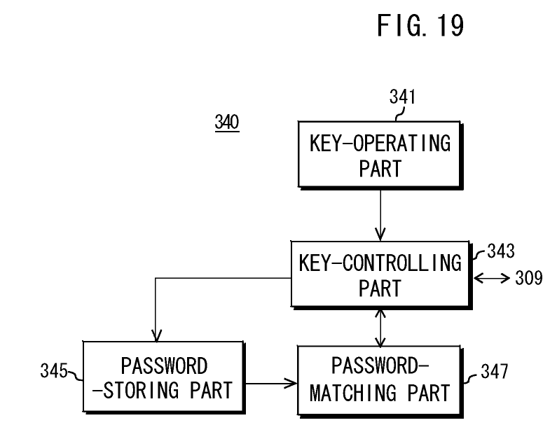

As shown in FIG. 19, the password-authenticating unit 340 contains a key-operating part 341, a key-controlling part 343, a password-storing part 345 and a password-matching part 347. The key-operating part 341 is formed on, for example, a surface of the display device 105Ba of the ID card 105B. The key-operating part 341 is configured as to become touch screen so that a numeric keypad is displayed on the display device 105Ba. A password (for example, numerals of 4 through 8 digits) is inputted using the key-operating part 341. The key-operating part 341 is connected to the key-controlling part 343. The key-controlling part 343 registers the inputted numeral password on the password-storing part 345 as password data. Such password data is not allowed to be changed if the password is once registered on the password-storing part 345.

To the key-controlling part 343, the password-matching part 347 is connected. The password-matching part 347 determines whether or not a password inputted by the key-operating part 341 is identical to the password registered on the password-storing part 345 as the password data (namely, it performs matching process). To the key-controlling part 343, the CPU 309 shown in FIG. 18 is also connected. The key-controlling part 343 outputs a result of the matching process of the passwords to the CPU 309.

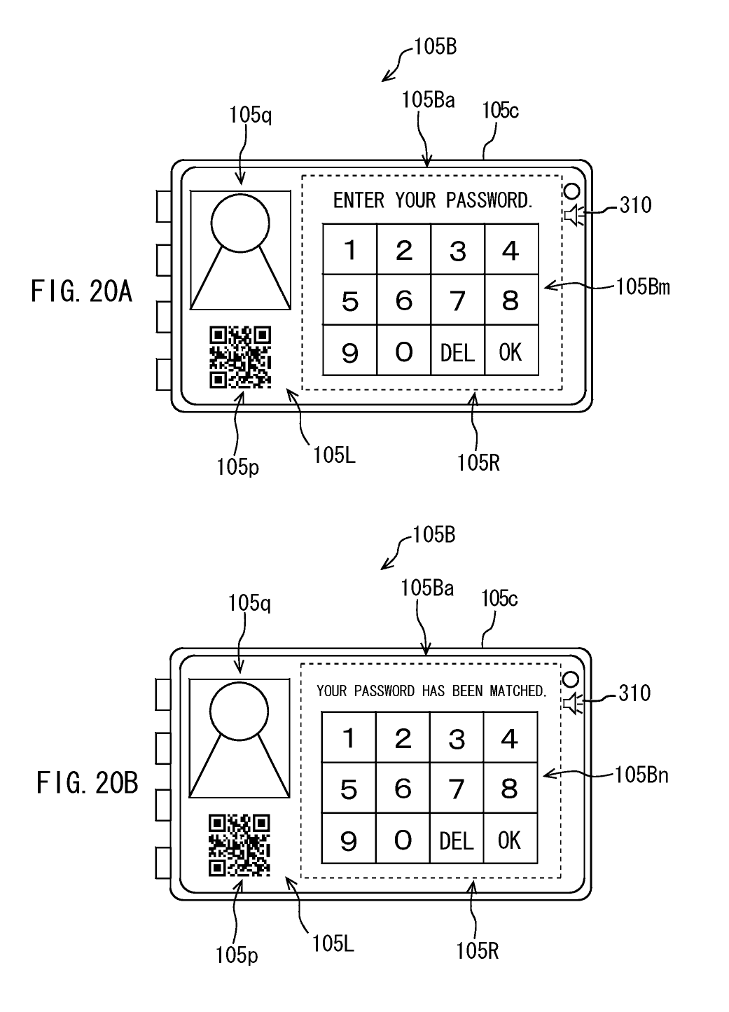

For example, the ID card 105B is powered on, the CPU 309 controls the display device 105Ba to display thereon a password request screen 105Bm, as shown in FIG. 20A, displaying the numeral keypad and a message, for example, “Enter your password.” When a holder of the ID card 105B inputs his or her password using the numeral keypad (the key-operating part 341) on the password request screen 105Bm after the password request screen 105Bm is displayed on the display device 105Ba, the key-operating part 341 outputs the inputted password to the key-controlling part 343. The key-controlling part 343 outputs the password outputted from the key-operating part 341 to the password-matching part 347 as the password data. The password-matching part 347 determines whether or not the password data outputted from the key-controlling part 343 is identical to the password data registered on the password-storing part 345 (namely, it performs matching process).

When the password-matching part 347 determines that the password data outputted from the key-controlling part 343 is identical to the password data registered on the password-storing part 345, the password-matching part 347 outputs password-matching information indicating that items of the password data are matched to the CPU 309 through the key-controlling part 343. When the CPU 309 receives the password-matching information from the password-matching part 347, the CPU 309 controls the display device 105Ba to display thereon a password-matching confirmation screen 105Bn, as shown in FIG. 20B, displaying a message, for example, “Your password has been matched.” When items of the password data are matched, the ID card 105B is available. When the password-matching part 347 determines that the password data outputted from the key-controlling part 343 is not identical to the password data registered on the password-storing part 345, the password-matching part 347 outputs password-unmatched information indicating that items of the fingerprint data are not matched to the CPU 309 through the key-controlling part 343. The CPU 309 controls the display device 105Ba to display thereon a password-unmatched confirmation screen displaying a message, for example, “Your password has not been matched.” When items of the password data are not matched, the ID card 105B is unavailable.

It is to be noted that although a case where the numeral keypad has been displayed on the password request screen 105Bm of the display device 105Ba to set the password by using the numeral keys has been described in this embodiment, the invention is not limited thereto: a character keypad may be displayed on the password request screen 105Bm of the display device 105Ba to set the password by using the character keys.

The print board 105i maybe provided with a timer in order to power the ID card 105A or 105B off when a period of time has been elapsed. In this case, in order to power the ID card 105A or 105B again on, it is necessary that the fingerprints or passwords are matched. This enables the security of ID card 105A or 105B to be further improved.

A special computer may use for deleting the fingerprint data registered on the fingerprint-data-storing part 325 of the ID card 105A or the password data registered on the password-storing part 345 of the ID card 105B as to become initial state of the ID card 105A or 105B. This enables an owner of the ID card 105A or 105B to be changed, which allows the ID card 105A or 105B to be often used.

Alternatively, any of the personal computers 170a through 170c, which are connected to the wireless network 103 through the personal computer controller 180, may communicate the wireless network 103 through the personal computer controller 180. Any of the personal computers 170a through 170c also sends information for collecting persons, for example, the employees within the firm to the ID cards 105 through the ID card controller 150 and the base stations 160a, 160b . . . , 160n, thereby enabling the employees within the firm to be collected soon.

The following will describe such an ID card 105C that enables the employees within the firm to be collected.

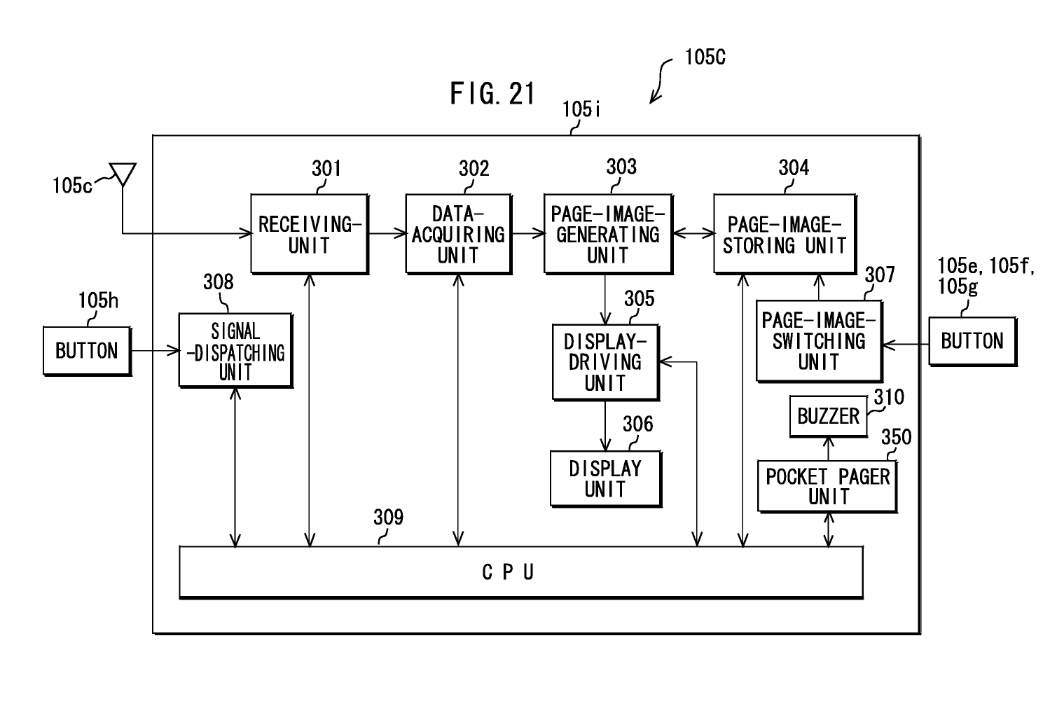

The ID card 105C is provided with a pocket pager unit 350 in addition to the ID card 105, as shown in FIG. 21. Like reference characters and numbers refer to like elements of the above-mentioned embodiments, explanation of which will be omitted. As shown in FIG. 21, the ID card 105C contains a print board 105i. The print board 105i mounts a receiving unit 301, a data-acquiring unit 302, a page-image-generating unit 303, a page-image-storing unit 304, a display-driving unit 305, a display unit 306, a page-image-switching unit 307, a signal-dispatching unit 308, CPU 309, a buzzer 310 and the pocket pager unit 350. The pocket pager unit 350 is used for collecting the particular employees within the firm.

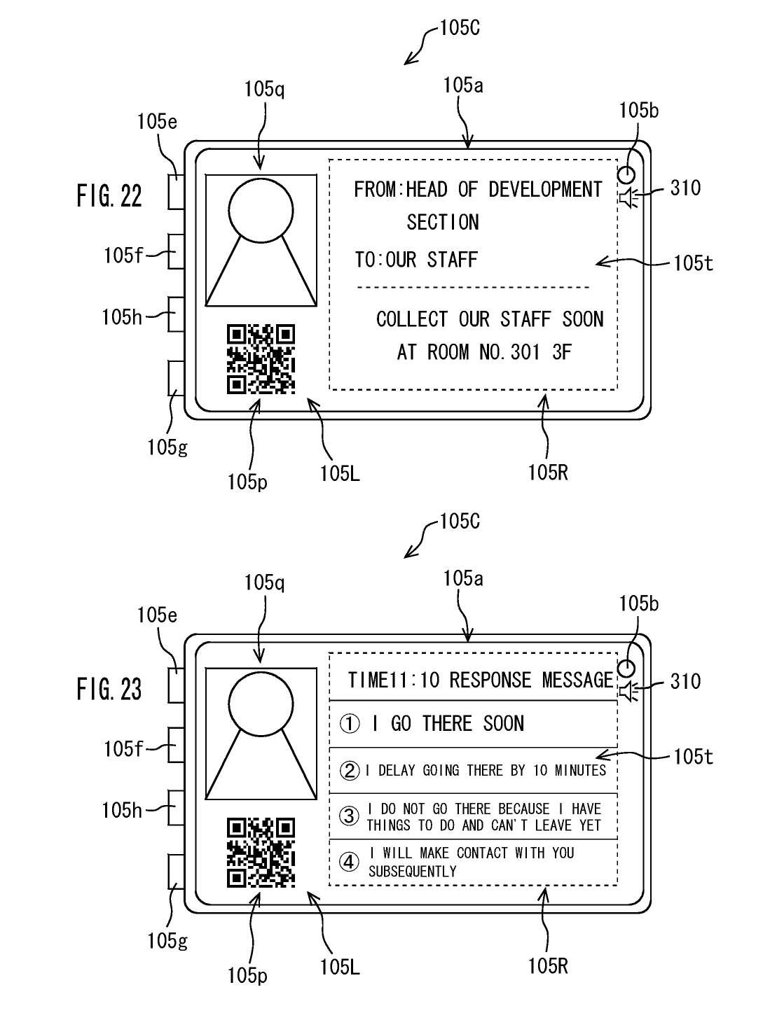

The personal computer 170a shown in FIG. 1A before, for example, a head of development section in the firm sends image data for collecting the employees to each ID card 105C stored on the identification controller 120 so that an employee having the PC card 105C has entered into the firm and has not yet exited, together with a vibration-generating signal and vibration data (if necessary, also sound data for the buzzer 310), through the PC controller 180 and the ID card controller 150 and the base stations 160a, 160b . . . , 160n in the wireless network 103. Each of the ID cards 105C then receives the image data, the vibration-generating signal and vibration data (if necessary, also the sound data). The CPU 309 of the received ID card 105C controls the pocket pager unit 350 to generate the vibration based on the vibration data with the vibration-generating signal (if necessary, the CPU 309 controls the pocket pager unit 350 to sound the buzzer 310 based on the sound data). The CPU 309 of the received ID card 105C simultaneously controls the pocket pager unit 350 to display an image for collecting the employees, as shown in FIG. 22, on the display unit 306. The employees each having the PC card 105C can know the collection command of the employees from the head of development section rapidly by seeing the image for collecting the employees, as shown in FIG. 22, on the display unit 306. This enables the ID card 105C to perform a packet pager function.

Further, the employee having the PC card 105C can respond to the collection command. When receiving the collection command, the PC card 105C can transmit a message such as the letters, “I go there soon” and “I delay going there by 10 minutes” to the personal computer 170a. Although such a message may be input by using the key-operating part 341 of the above-mentioned touch screen, it maybe easily called by storing various kinds of massages on, for example, the page-image-storing unit 304 as fixed messages. In other words, when receiving the collection command, the employee switches the page image by using the page-image-switching unit 307 and the button 105e, 105f or 105g to open a response message menu screen in which various kinds of massages such as the letters, “I go there soon”, “I delay going there by 10 minutes”, “I do not go there because I have things to do and can't leave it” and “I will make contact with you subsequently” are displayed, as shown in FIG. 23. When the employee touches a portion on the touch screen, which corresponds to a message that he wants to transmit, the CPU 309 of the PC card 105C may control the signal-dispatching unit 308 to transmit the message to the personal computer 170a.

This invention is preferably applicable to the identification card for identifying a person and an identification network system using the same.

While the foregoing specification has described preferred embodiment(s) of the present invention, one skilled in the art may make many modifications to the preferred embodiment without departing from the invention in its broader aspects. The appended claims therefore are intended to cover all such modifications as fall within the true scope and spirit of the invention.

The present application contains subject matter related to that disclosed in Japanese Priority Patent Applications No. 2009-251407 and 2009-298927 respectively filed in the Japanese Patent Office on Oct. 30, 2009, and Dec. 28, 2009, the entire contents of which are hereby incorporated by reference.

What is claimed is:

1. An identification card comprising:
an identification portion that contains identification information for identifying a person;
a wireless-information-receiving portion that receives wireless information;
an output-information-generating portion that generates output information from the wireless information received by the wireless-information-receiving portion; and
an output-information-displaying portion that receives the output information from the output-information-generating portion to display the output information.

2. The identification card according to claim 1, further comprising:
an output-information-storing portion that stores the output information; and
a switching portion that switches the output information stored in the output-information-storing portion,
wherein the output-information-displaying portion displays the output information switched by the switching portion.

3. The identification card according to claim 1 wherein the identification information includes an identification cord and the identification information is read by using the identification cord; and
wherein the identification card is used for opening a gate of a building by using the read identification information.

4. The identification card according to claim 1, further comprising a transmitting portion that transmits the identification information using a radio wave,
wherein the identification information transmitted using the radio wave is read; and
wherein the identification card is used for opening a gate of a building by using the read identification information.

5. The identification card according to claim 1 further comprising a light-emitting device that emits light while the wireless-information-receiving portion receives the wireless information.

6. The identification card according to claim 2 wherein the output information includes a plurality of rewritable images; and
wherein the switching portion switches the rewritable images based on the wireless information received by the wireless-information-receiving portion.

7. The identification card according to claim 1 further comprising sounding device that sounds when the wireless-information-receiving portion receives the wireless information.

8. The identification card according to claim 1 further comprising warning device that warns while the wireless-information-receiving portion does not receive the wireless information.

9. The identification card according to claim 2 further comprising a vibration-generating device that generates a vibration when the wireless-information-receiving portion receives the wireless information.

10. A network system comprising:
a wireless network that sends wireless information using a radio wave;
an identification card that contains identification information for identifying a person and receives the wireless information from the wireless network to display the wireless information; and
an identification network that reads the identification information from the identification card to identify the person.

11. The network system according to claim 10 wherein the identification card comprises:
an identification portion that contains the identification information for identifying the person;
a wireless-information-receiving portion that receives the wireless information from the wireless network;
an output-information-generating portion that generates output information from the wireless information received by the wireless-information-receiving portion; and
an output-information-displaying portion that receives the output information from the output-information-generating portion to display the output information.

12. The network system according to claim 11 wherein the identification card further comprises:
an output-information-storing portion that stores the output information; and
a switching portion that switches the output information stored in the output-information-storing portion,
wherein the output-information-displaying portion displays the output information switched by the switching portion.

13. The network system according to claim 11 wherein the identification information contains an identification cord;
wherein the identification network includes:
an identification-cord-reading device that scans the identification cord to read the identification information; and
an identification controller that controls entrance and exit of the person based on the identification cord read by the identification-cord-reading device;
wherein the identification network contains previously registered identification information; and
wherein the identification controller collates the identification information read by the identification-cord-reading device with the previously registered identification information to allow for opening a gate of a building when the pieces of the identification information are agreed with each other.

14. The network system according to claim 11 wherein the identification card further comprises a transmitting portion that transmits the identification information using a radio wave to the identification network;
wherein the identification card is used for opening a gate of a building by using the read identification information;
wherein the identification network includes:
an identification-information-reading device that receives and reads the identification information; and
an identification controller that controls entrance and exit of the person based on the identification information read by the identification-information-reading device;
wherein the identification network contains previously registered identification information; and
wherein the identification controller collates the identification information read by the identification-information-reading device with the previously registered identification information to allow for opening the gate of the building when the pieces of the identification information are agreed with each other.

15. The network system according to claim 10 wherein the wireless network contains a plurality of base stations and each of the base stations contains a propagation region into which the radio signal is sent, said radio signal being differed for every base station.

16. The network system according to claim 13 wherein pieces of the information which are sent into the propagation regions and are differed for every base station are selected so as to be made identical with each other or to be made different from each other.

17. The network system according to claim 15 wherein the identification card receives the pieces of the identification information from the wireless network to display each of the pieces of the identification information as one image; and
wherein the images are displayable one at a time.

18. The network system according to claim 10 wherein the identification card further contains sounding device that sounds when the wireless-information-receiving portion receives the wireless information.

19. The network system according to claim 10 wherein the identification card further contains warning device that warns while the wireless-information-receiving portion does not receive the wireless information if the identification card requests desired information to the wireless network.

20. The network system according to claim 10 further comprising a personal computer that communicates the wireless network, wherein the personal computer sends information for collecting persons to the identification card through the wireless network.

21. The network system according to claim 12 wherein the identification card further comprises a vibration-generating device that generates a vibration when the wireless-information-receiving portion receives the wireless information.
